(19) United States
(12) Patent Application Publication
(10) Pub. No.: US 2020/0160400 A1
(43) Pub. Date: May 21, 2020

(54) COMPUTER-IMPLEMENTED METHOD OF SELECTING CONTENT, CONTENT SELECTION SYSTEM, AND COMPUTER-READABLE RECORDING MEDIUM

(71) Applicant: NEC Corporation, Tokyo (JP)

(72) Inventor: Chisato OKAWA, Tokyo (JP)

(73) Assignee: NEC Corporation, Tokyo (JP)

(21) Appl. No.: 16/687,835

(22) Filed: Nov. 19, 2019

(30) Foreign Application Priority Data
Nov. 21, 2018 (JP) 2018-217961

(51) Int. Cl. G06Q 30/02

(52) U.S. Cl. CPC G06Q 30/0271; G06Q 30/0261

(57) ABSTRACT

A computer-implemented method of selecting content, the method performed by one or more processors, according to an example aspect of the present disclosure, includes: receiving image data captured by an image device; recognizing a characteristic of person with respect to each of a plurality of persons included in the image data; predicting an advertisement effect on the plurality of persons for each of contents based on the characteristic of person; selecting a presentation content based on the advertisement effect, the presentation content being a content to present to the plurality of persons; and displaying the presentation content on an output device.

This application is based upon and claims the benefit of priority from Japanese Patent Application No. 2018-217961, filed on Nov. 21, 2018, the disclosure of which is incorporated herein in its entirety by reference.

### TECHNICAL FIELD

The present disclosure relates to a technique for selecting a content.

### BACKGROUND ART

A system, which is called digital signage and dispatches information by using an electronic apparatus, is used in a store, a public facility, and the like.

In the digital signage, a content to be output is generally switched based on a rule being statically determined. In recent years, in order to improve an appealing effect of a content, namely, an advertisement effect, a method of capturing an image of a fixed range by using an image device, dynamically determining a rule based on information about a person included in image data, and switching a content is known.

For example, in Japanese Unexamined Patent Application Publication No. 2009-245364, a characteristic (sex and age) of a person who recognizes an advertisement among persons included in image data, the number of persons for each characteristic, and date and time at which an advertisement is distributed are recorded, and a characteristic of a person who recognizes an advertisement and the number of persons are predicted as an advertisement effect for each advertisement frame. Then, an advertisement to be distributed in each advertisement frame is determined based on the predicted advertisement effect.

Further, as a related technique, in Japanese Unexamined Patent Application Publication No. 2008-102176, the front of a screen and a store are captured by using an image device. Then, an advertisement effect of an advertisement content is analyzed by comparing a facial feature of a person who looks at the advertisement content with a facial feature of a person who comes to the store, and acquiring the number of persons who are determined as the same person.

### SUMMARY

As described above, the digital signage is often used at a place where many persons gather, such as a store and a public facility. Thus, when a rule for switching a content is dynamically determined, a content having a high advertisement effect on a plurality of persons needs to be output.

The present disclosure has been made in view of the above-described problem, and a main object thereof is to provide a technique for selecting a content having a high advertisement effect on a plurality of persons included in image data.

A computer-implemented method of selecting content, the method performed by one or more processors, according to an example aspect of the present disclosure, includes:

receiving image data captured by an image device;

recognizing a characteristic of person with respect to each of a plurality of persons included in the image data;

predicting an advertisement effect on the plurality of persons for each of contents based on the characteristic of person;

selecting a presentation content based on the advertisement effect, the presentation content being a content to present to the plurality of persons; and

displaying the presentation content on an output device.

A content selection system according to an example aspect of the present disclosure, includes:

a content selection device that includes a processor configured to:

recognize a characteristic of person with respect to each of a plurality of persons included in image data,

predict an advertisement effect on the plurality of persons for each of contents based on the characteristic of person, and select a presentation content to the plurality of persons based on the advertisement effect, the presentation content being a content to present to the plurality of persons;

an image device that generates the image data; and

an output device that acquires a content ID to indicate the presentation content from the content selection device, and outputs the presentation content selected based on the content ID.

A non-transitory computer-readable recording medium that stores a program causing a computer according to an example aspect of the present disclosure to execute:

receiving image data captured by an image device;

recognizing a characteristic of person with respect to each of a plurality of persons included in the image data;

predicting an advertisement effect on the plurality of persons for each of contents based on the characteristic of person;

selecting a presentation content based on the advertisement effect, the presentation content being a content to present to the plurality of persons; and

displaying the presentation content on an output device.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a hardware configuration of a computer device that achieves a content selection device according to each example embodiment;

FIG. 2 is a diagram schematically illustrating one example of a configuration of a content selection system according to a first example embodiment;

FIG. 3 is a block diagram illustrating a functional configuration of the content selection system according to the first example embodiment;

FIG. 4 is a diagram illustrating one example of characteristic recognition information generated by a characteristic recognition unit according to the first example embodiment;

FIG. 5 is a flowchart illustrating an operation of an analysis server in an analysis phase according to the first example embodiment;

FIG. 6 is a diagram illustrating one example of learning information generated by the analysis server according to the first example embodiment;

FIG. 7 is a flowchart illustrating an operation of a content selection device in a prediction phase according to the first example embodiment;

FIG. 8 is a diagram illustrating one example of a result which is calculated by an advertisement effect prediction unit and is predicted an advertisement effect on a plurality of persons for each content according to the first example embodiment;

FIG. 9 is a diagram illustrating one example of learning information generated by an analysis server according to a modification example of the first example embodiment;

FIG. 10 is a block diagram illustrating one example of a functional configuration of a content selection device according to a second example embodiment;

FIG. 11 is a diagram illustrating one example of a calculation result of a priority of a content to be output from the content selection device according to the second example embodiment; and

FIG. 12 is a block diagram illustrating one example of a functional configuration of a content selection device according to a third example embodiment.

### EXAMPLE EMBODIMENT

Hereinafter, example embodiments of the present disclosure are described in detail with reference to drawings.

### First Example Embodiment

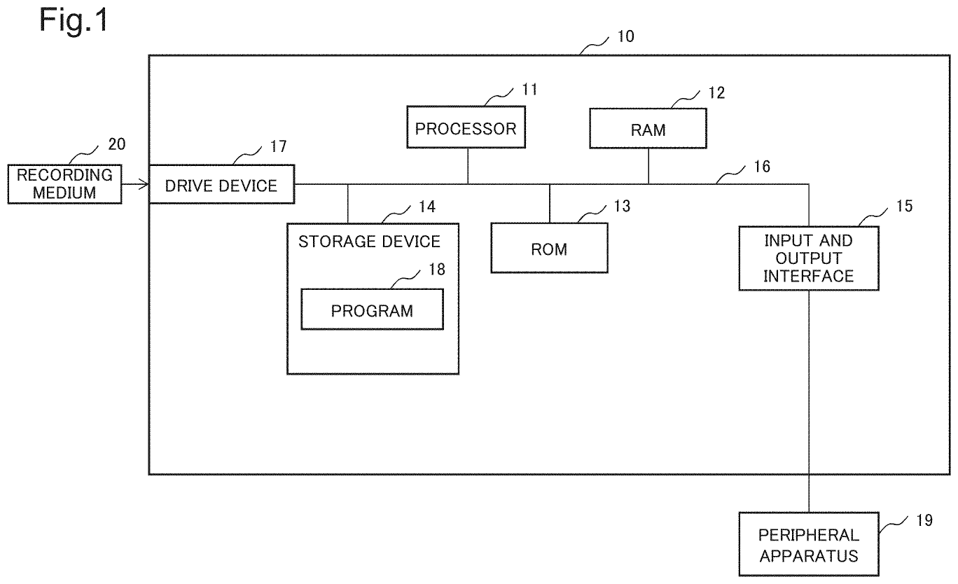

Hardware constituting a content selection device according to a first example embodiment and other example embodiments is described. FIG. 1 is a block diagram illustrating a hardware configuration of a computer device that achieves the content selection device according to each of the example embodiments. Each block illustrated in FIG. 1 can be achieved by any combination of a computer device 10 that achieves the content selection device and a content selection method according to each of the example embodiments, and software.

As illustrated in FIG. 1, the computer device 10 includes a processor 11, a random access memory (RAM) 12, a read only memory (ROM) 13, a storage device 14, an input and output interface 15, and a bus 16.

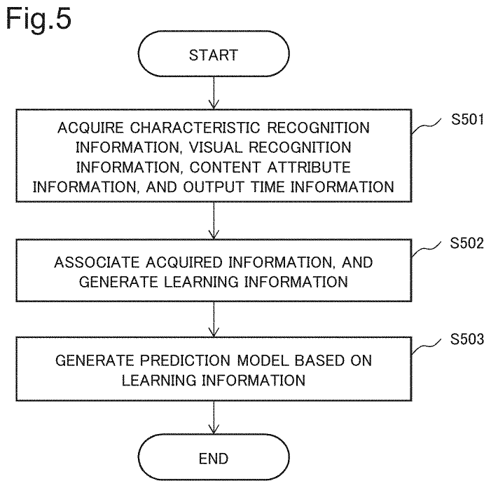

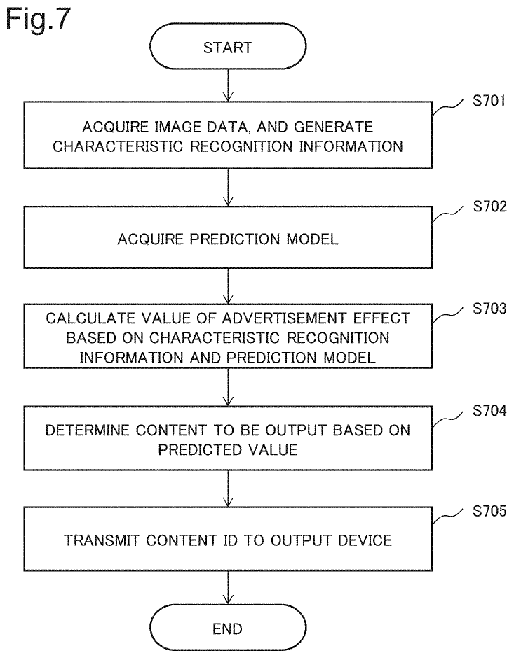

The storage device 14 stores a program 18. The processor 11 executes the program 18 related to the content selection device by using the RAM 12. Specifically, for example, the program 18 includes a program that causes a computer to execute processing illustrated in FIGS. 5 and 7, and the like. The processor 11 executes the program 18, and thus a function of each component (a characteristic recognition unit 111, an advertisement effect prediction unit 112, and a content selection unit 113, which are described later) of the content selection device is achieved. The program 18 may be stored in the ROM 13. Further, the program 18 may be recorded in a recording medium 20 and may be read out by a drive device 17, or may be transmitted from an external device via a network.

The input and output interface 15 exchanges data with a peripheral apparatus (such as a keyboard, a mouse, and a display device) 19. The input and output interface 15 functions as a means for acquiring and outputting data. The bus 16 connects each component.

Note that, a method for achieving the content selection device has various modification examples. For example, the content selection device can be achieved as a dedicated device. Further, the content selection device can be achieved by a combination of a plurality of devices.

A processing method for recording, in a recording medium, a program for achieving each component in a function of the first example embodiment, a second example embodiment, and a third example embodiment, reading the program recorded in the recording medium as a code, and executing the code in a computer is also included in a category of each of the example embodiments. In other words, the computer-readable recording medium is also included within a scope of each of the example embodiments. Further, the recording medium, which stores the above-described program, is included in each of the example embodiments, and its program itself is also included in each of the example embodiments.

As the recording medium, for example, a floppy (registered trademark) disc, a hard disc, an optical disc, a magneto-optical disc, a compact disc (CD)-ROM, a magnetic tape, a non-volatile memory card, or a ROM can be used. Further, a program is not limited to a program alone that is recorded in the recording medium and executes processing. A program that operates on an operating system (OS) in cooperation with other software and a function of an expansion board and executes processing is also included in a category of each of the example embodiments.

Next, an outline of each component of a content selection system for controlling digital signage is described.

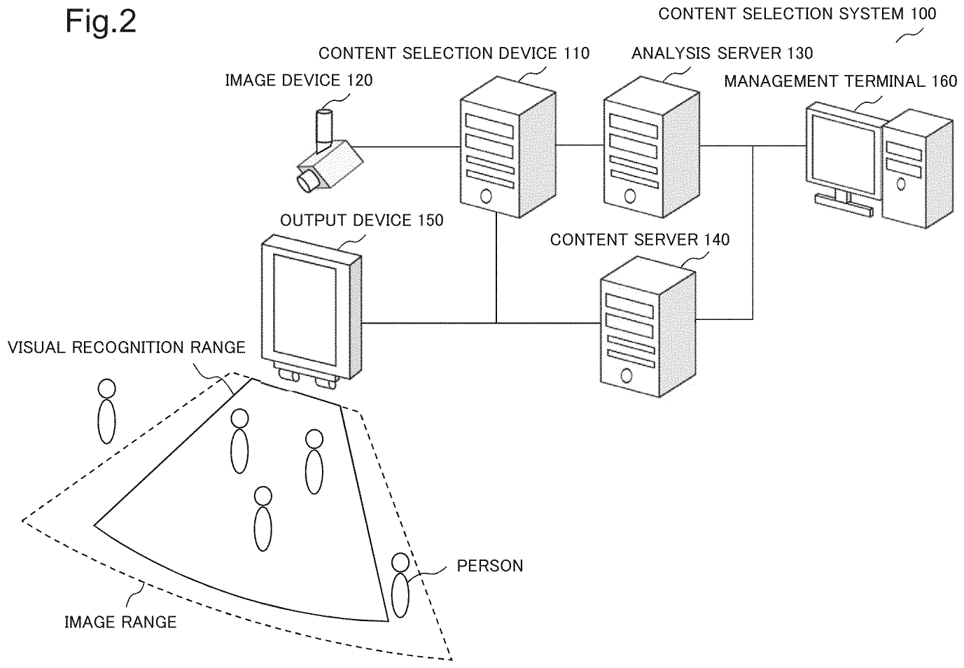

FIG. 2 is a diagram schematically illustrating one example of a configuration of the content selection system according to the first example embodiment. As illustrated in FIG. 2, a content selection system 100 includes a content selection device 110, an image device 120, an analysis server 130, a content server 140, an output device 150, and a management terminal 160. The content selection system 100 is a system that outputs a content to the output device 150 based on control by at least the content selection device 110.

In the specification, the content is, for example, an advertisement and news. A presentation form of the content includes a still image, a moving image, a voice, and a combination thereof, but may be other than these.

In the first example embodiment, it is assumed that a person located in a predetermined range near the output device 150 can visually recognize a content output from the output device 150. Herein, the predetermined range near the output device 150 is represented by a range (hereinafter, referred to as a “visual recognition range”) indicated by a solid line in front of the output device 150 in FIG. 2. The visual recognition range is, for example, a range in front of the output device 150 and within a five-meter radius of the center of a place where the output device 150 is installed. The visual recognition range may be a range with five-meter sides in front of the output device 150.

The content selection device 110 is connected to the image device 120, the analysis server 130, the content server 140, and the output device 150 in such a way as to be able to communicate with each other.

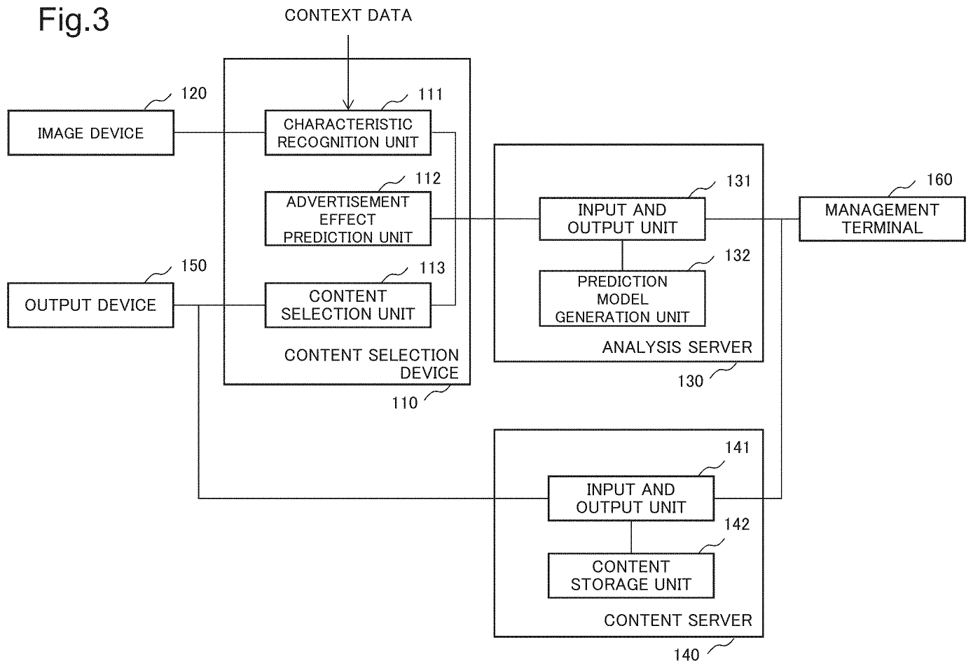

FIG. 3 is a block diagram illustrating a functional configuration of the content selection system 100 illustrated in FIG. 2. Each block in the content selection device 110, the analysis server 130, and the content server 140 illustrated in FIG. 3 may be mounted in a single device, or may be separately mounted in a plurality of devices. Giving and receiving of data between blocks are performed via a connection means such as a data bus, a network, and a portable storage medium.

As illustrated in FIG. 3, the content selection device 110 includes the characteristic recognition unit 111, the advertisement effect prediction unit 112, and the content selection unit 113. The content selection device 110 has a function of selecting a content to be output from the output device 150 by using information received from the image device 120 and the analysis server 130, and the like.

The image device 120 is a device that captures an image of a predetermined range. A range captured by the image device 120 is referred to as an image range. In FIG. 2, a range indicated by a dotted line in front of the output device 150 is an image range. The image range includes the visual recognition range. The image device 120 captures an image of the predetermined range, and generates and transmits image data to the content selection device 110.

The analysis server 130 includes an input and output unit 131 and a prediction model generation unit 132. The analysis server 130 is communicably connected to the content selection device 110 and the management terminal 160. The input and output unit 131 acquires information from the content selection device 110 and the management terminal 160. The prediction model generation unit 132 generates a prediction model based on the information acquired in the input and output unit 131 (details are described later). The prediction model is a model for predicting an advertisement effect.

The content server 140 includes an input and output unit 141 and a content storage unit 142. The content server 140 is communicably connected to the management terminal 160. The input and output unit 141 associates actual data about a content acquired from the management terminal 160 with information for identifying the content, and stores the actual data in the content storage unit 142.

The output device 150 is a signage terminal that displays a content such as video and a letter by a flat-panel display, a projector, and the like. Herein, it is assumed that, when the output device 150 presents a content, data about the content to be presented are acquired from the content server 140. In this case, when acquisition of the data about the content fails due to a problem caused by a band or quality of a network line, a content cannot be presented stably. In consideration of such a concern, the output device 150 includes a storage device such as a hard disc, previously acquires a plurality of contents to be selected by the content selection device 110 from the content server 140, and accumulates the plurality of contents. Then, the output device 150 reproduces the selected content based on information acquired from the content selection device 110, and outputs the selected content to the flat-panel display and the like. In addition, hereinafter, the contents to be selected by the content selection device 110 is also referred to as a output candidate content.

Note that, an accumulation and reproduction type that previously accumulates and reproduces a content is adopted as a moving image distribution method to the output device 150 in the first example embodiment, alternatively, for example, when a communication situation is stable and it is conceivable that the concern as described above does not need to be taken into consideration, a streaming type that receives a content by streaming distribution and reproduces and outputs the content may be adopted.

The management terminal 160 is an information processing device including an input and output device to manage the content selection system 100. The management terminal 160 may be, for example, a personal computer. The management terminal 160 transmits, to the analysis server 130, content attribute information for designating a content to be output to the output device 150. The content attribute information includes at least a content identification (ID) being information for identifying a content. Further, the management terminal 160 transmits the content attribute information and actual data about the content to the content server 140.

FIGS. 2 and 3 illustrate the content selection device 110 as an independent device, which is not limited thereto. In other words, for example, the content selection device 110 may be included in the output device 150. Further, the content selection device 110 may be included in a device where the image device 120, the analysis server 130, the content server 140, and the output device 150 are integrated. Further, each of the content selection device 110, the analysis server 130, and the content server 140 may be constructed in an on-premises environment, or may be constructed in a cloud environment.

Next, each component of the content selection device 110 is described.

The characteristic recognition unit 111 receives image data from the image device 120, detects a plurality of persons included in the image data, and also recognizes a characteristic of person with respect to a person which is each of the detected plurality of persons. Herein, the characteristic of person includes, for example, sex, age, a posture, a facial expression, clothing, and a body shape, belongings held by the person, a walking speed of the person, a distance between the person and the output device 150, and the like, but not limited thereto. When the characteristic recognition unit 111 detects a person, the characteristic recognition unit 111 provides identification information about the person in order to identify the person included in the image data. The characteristic recognition unit 111 recognizes a characteristic for each detected person, and generates data (hereinafter, referred to as “characteristic recognition information”) in which the recognized characteristic is associated with identification information about the person. In other words, the characteristic recognition unit 111 has a function of recognizing a characteristic of person with respect to the plurality of persons included in image data.

The characteristic recognition unit 111 may generate the characteristic recognition information in which context data are associated in addition to the characteristic of person and the identification information about the person.

The context data are information about an environment of displaying a content. The context data are information about, for example, weather, temperature, event information, a congestion degree of persons or vehicles, date and time, a place, and the like, which is not limited thereto. For example, the characteristic recognition unit 111 acquires the context data by using a sensor or a global positioning system (GPS), which is not illustrated. Instead of this, the characteristic recognition unit 111 may acquire, as context data, open data acquired via a network or system time of each device.

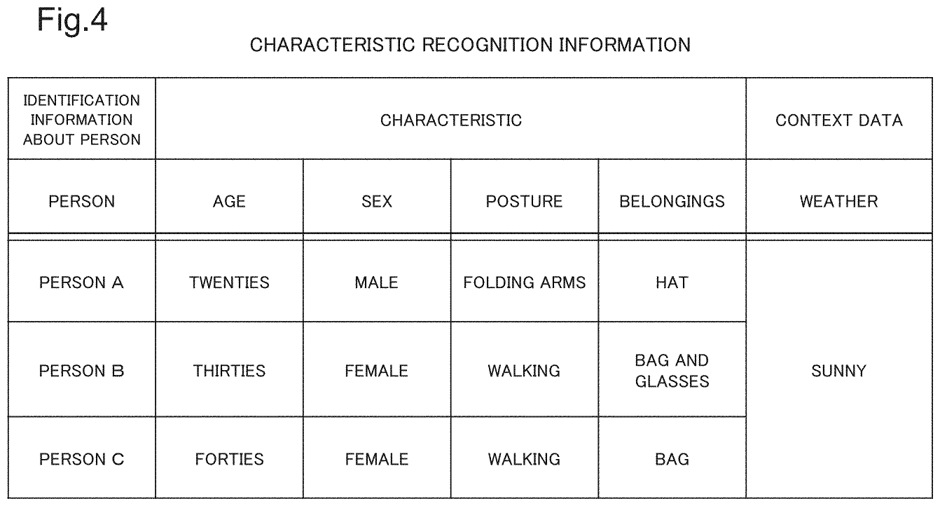

FIG. 4 is a diagram illustrating one example of the characteristic recognition information generated by the characteristic recognition unit 111. As illustrated in FIG. 4, the characteristic recognition information includes identification information about a person detected from image data, a characteristic of person (herein, age, sex, a posture, and belongings), and context data (herein, weather). The characteristic recognition unit 111 may generate the characteristic recognition information at each fixed period of time based on image data received from the image device 120.

The advertisement effect prediction unit 112 predicts a value of an advertisement effect for each content on the person recognized by the characteristic recognition unit 111 (calculates a prediction value). Specifically, the advertisement effect prediction unit 112 predicts the value of the advertisement effect on the plurality of the recognized persons for each output candidate content held by the output device 150 based on the characteristic recognition information acquired from the characteristic recognition unit 111 and the prediction model acquired from the analysis server 130. In other words, the advertisement effect prediction unit 112 has a function of predicting based on the characteristic of person concerning the plurality of persons recognized by the characteristic recognition unit 111, an advertisement effect on the plurality of persons for each content.

The content selection unit 113 selects a content to be output from the output device 150 based on the value of the advertisement effect predicted by the advertisement effect prediction unit 112. Specifically, the content selection unit 113 selects a content predicted to have the highest advertisement effect from among a plurality of output candidate contents. The content selection unit 113 transmits the content ID of the selected content to the output device 150. In other words, the content selection unit 113 has a function of selecting the content to be presented to the plurality of persons based on the advertisement effect predicted by the advertisement effect prediction unit 112. The content selected by the content selection unit 113 is also referred to as “presentation content”.

Next, an operation of the content selection system 100 according to the first example embodiment is described. The operation of the content selection system 100 according to the first example embodiment includes an analysis phase and a prediction phase. In the analysis phase, the content selection system 100 analyzes the advertisement effect on each person for each content, and generates the prediction model. In the prediction phase, the content selection system 100 selects the content having the higher advertisement effect on the plurality of persons included in the image data by using the prediction model, and outputs the selected content.

Herein, the advertisement effect is an indicator indicating an effect of a content appealing to a person. For example, the advertisement effect is a frequency of a person located in the visual recognition range coming to a store related to the presented content. Alternatively, the advertisement effect is a degree to which a person who visually recognizes a content picks up a product related to the presented content. The advertisement effect is not limited to those, and any indicator may be used as the advertisement effect as long as it is an indicator capable of indicating the effect of a content appealing to a person. In the first example embodiment, a value indicating whether the plurality of persons located in the visual recognition range visually recognize a content is used as the advertisement effect.

The analysis phase is described. In the analysis phase according to the first example embodiment, the content selection system 100 analyzes a relationship among the characteristic of person, the context data, and a fact that the person included in the image data visually recognizes a content. Then, the content selection system 100 generates the prediction model for predicting an individual advertisement effect from the characteristic of person.

In the analysis phase, the content selection device 110 controls output of the content ID in such a way that a content is output from the output device 150 at a predetermined time based on the content ID acquired from the management terminal 160. Specifically, the management terminal 160 transmits the content attribute information to the content selection device 110 via the analysis server 130. On this occasion, the content attribute information may include a content category indicating a category information of content such as an advertisement and news, in addition to the content ID. Further, the management terminal 160 transmits actual data about the content to the content server 140.

When the content selection device 110 acquires the content attribute information, the content selection unit 113 transmits the content ID to the output device 150. When receiving the content ID, the output device 150 reproduces a content associated with the content ID from among the plurality of output candidate contents being previously acquired from the content server 140 and accumulated, and outputs the content to a flat-panel display and the like.

The image device 120 captures the image of an image range at least while the output device 150 outputs the content, and transmits the image data to the content selection device 110.

When receiving the image data from the image device 120, the characteristic recognition unit 111 detects the person included in the image data, and also recognizes the characteristic of person about the detected person, and generates the characteristic recognition information. On this occasion, the characteristic recognition unit 111 determines whether the detected person visually recognizes the content. The characteristic recognition unit 111 generates the visual recognition information indicating a result of determining whether the person visually recognizes the content, and transmits the visual recognition information together with the characteristic recognition information to the analysis server 130. Herein, the characteristic recognition unit 111 detects, for example, a direction of a face or a direction of a line of sight of the person, and measures a period of time for which the face or the line of sight is directed toward the output device 150. Then, when the face or the line of sight is directed toward the output device 150 for a predetermined period of time, the characteristic recognition unit 111 determines that the person visually recognizes the content. Note that, a determination method may determine whether the detected person visually recognizes the content. For example, as the determination method, another method for detecting a walking speed of a person, determining that the person whose the walking speed decreases at a predetermined rate or more visually recognizes a content, and the like may be used.

The characteristic recognition unit 111 generates the characteristic recognition information and the visual recognition information based on the recognized characteristic of person recognized and a visual recognition result while the output device 150 outputs a content. Herein, the characteristic recognition unit 111 may generate the characteristic recognition information based on the characteristic of person and the visual recognition result in a fixed period of time while the content is output. Timing of generating the characteristic recognition information may be set for each content to be output, or may be set uniformly.

FIG. 5 is a flowchart illustrating an operation of the analysis server 130 in the analysis phase. Hereinafter, each step in the flowchart is expressed by using a number provided to each step, such as “S501”, in the specification.

In the analysis server 130, the input and output unit 131 acquires from the content selection device 110, the characteristic recognition information, the visual recognition information, the content attribute information, and information (hereinafter, referred to as output time information) about time at which a content is output (S501).

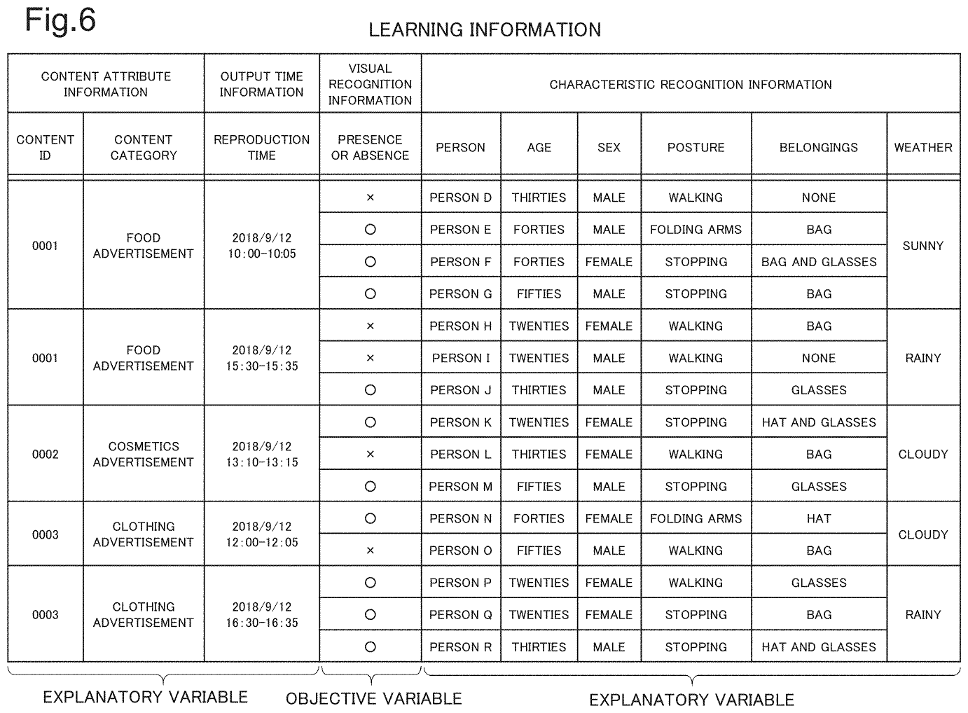

The prediction model generation unit 132 generates data. The data associates the characteristic recognition information, the visual recognition information, the content attribute information, and the output time information with each other (S502). Hereinafter, the data are associated with each other are referred to as “learning information”. FIG. 6 is a diagram illustrating one example of learning information. In FIG. 6, “∘” indicates that a person visually recognizes the content, and “x” indicates that a person does not visually recognize the content.

The prediction model generation unit 132 generates the prediction model for predicting the advertisement effect (the value indicating whether the visual recognition is performed) by using the learning information (S503). For example, the prediction model generation unit 132 generates the prediction model with, as an objective variable, information (“presence or absence” of “visual recognition information” in FIG. 6) indicating whether the content is visually recognized, and with, as an explanatory variable, other information (“content ID”, “reproduction time”, “content category”, “age”, “sex”, “posture”, “belongings”, and “weather” in FIG. 6). For example, the objective variable sets a label value to 1 when a content is visually recognized, and sets the label value to −1 when the content is not visually recognized. For example, a value acquired by replacing each piece of information with a numerical value is set for the explanatory variable. The prediction model is represented by, for example, an identification function expressed in Equation 1 below.

Identification function f(x) for determining whether visual recognition is performed=α₀×“content ID”+α₁×“reproduction time+ . . . +α_{N-1}×“weather” (Equation 1)

where, αₙ (n is an integer from 0 to N−1, N is a number of an explanatory variable) is a coefficient of each explanatory variable.

Various statistical techniques or various techniques of machine learning are used for generation of the prediction model as described above. A value of αₙ is acquired by the statistical technique or the technique of machine learning being used. The prediction model generation unit 132 generates the prediction model, and stores the prediction model in a memory (not illustrated) of the analysis server 130. The prediction model with “presence or absence” of “visual recognition information” as an objective variable may be set for each characteristic or each content ID.

Next, the prediction phase is described. In the prediction phase according to the first example embodiment, the content selection system 100 selects the content having the higher advertisement effect on the plurality of persons included in the image data based on the prediction model generated as described above, and outputs the content. FIG. 7 is a flowchart illustrating an operation of the content selection device 110 in the prediction phase.

The image device 120 captures the image of the image range, and transmits the image data to the characteristic recognition unit 111.

The characteristic recognition unit 111 receives the image data from the image device 120, recognizes the characteristic of the person included in the image data, namely, the person located in the image range, and generates the characteristic recognition information (S701). On this occasion, the characteristic recognition unit 111 may generate the characteristic recognition information related to all persons located in the image range, which is not limited thereto.

For example, the characteristic recognition unit 111 may recognize the direction of the face or the body of the person, and generate the characteristic recognition information targeted for persons directed toward the output device 150 or some of persons directed toward the output device 150. Further, the characteristic recognition unit 111 may generate the characteristic recognition information targeted for persons remaining in the visual recognition range or some of persons remaining in the visual recognition range, when the content is presented.

Alternatively, for example, the characteristic recognition unit 111 may recognize the direction of the face or the body of the person, and generate the characteristic recognition information that excludes information about a person turning his and/or her back on the output device 150. Further, the characteristic recognition unit 111 may generate the characteristic recognition information that excludes information about a person going past the visual recognition range when a content is presented. The characteristic recognition unit 111 may specify the person going past the visual recognition range by using information about a movement direction calculated from a direction of a body of a moving person and information about a position of the person. As described above, the advertisement effect can be predicted by previously excluding a person having a low possibility of visually recognizing the content, and thus an effect capable of improving precision of predicting the advertisement effect can be achieved.

It is assumed that the characteristic recognition unit 111 generates the characteristic recognition information illustrated in FIG. 4. The advertisement effect prediction unit 112 acquires the characteristic recognition information from the characteristic recognition unit 111. Further, the characteristic recognition unit 111 acquires the prediction model from the analysis server 130 (S702). The advertisement effect prediction unit 112 predicts the value of the advertisement effect on a person A, a person B, and a person C for each output candidate content based on the characteristic recognition information and the prediction model (S703). In this example, the output candidate content is a content associated with the content ID of the content attribute information acquired in the analysis phase.

Specifically, first, the individual advertisement effect is predicted for each person in Step S703. For example, when the individual advertisement effect on the person A is predicted, the advertisement effect prediction unit 112 inputs “age”, “sex”, “posture”, and “belongings” of the person A, “weather”, “content ID” of a content that can be output, and “reproduction time” of the content in the characteristic recognition information. The advertisement effect prediction unit 112 outputs “1” when it is predicted that the person A visually recognizes the content, and “−1” when it is predicted that the person A does not visually recognize the content, by using the value calculated based on the input. The advertisement effect prediction unit 112 sets the value of “1” or “−1” output as the individual advertisement effect, and outputs the individual advertisement effect on the person A for each content.

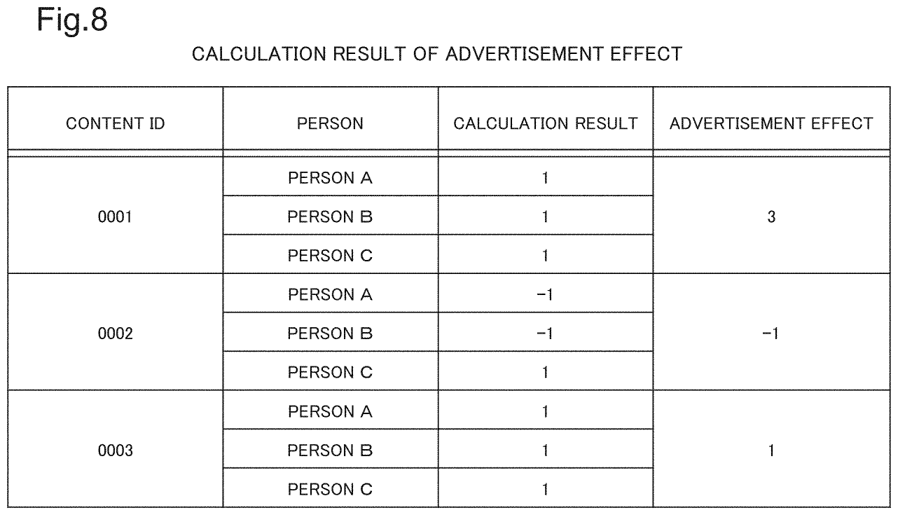

FIG. 8 is a diagram illustrating one example of the result of predicting the value of the advertisement effect on the plurality of persons for each content. For example, as illustrated in FIG. 8, the advertisement effect prediction unit 112 predicts the value of the individual advertisement effect of a content of each of content IDs “0001”, “0002”, and “0003” on each of the person A, the person B, and the person C. Then, the advertisement effect prediction unit 112 totals values of individual advertisement effects for each content, and uses the totaled value as the advertisement effect of the content. The advertisement effect prediction unit 112 transmits the predicted value of the advertisement effect to the content selection unit 113.

The content selection unit 113 acquires the value of the advertisement effect predicted by the advertisement effect prediction unit 112, and selects the content having the highest value of the advertisement effect as a content to be output from among the output candidate contents (S704). In the example illustrated in FIG. 8, the content associated with the content ID “0001” having the highest total value of the values of the individual advertisement effects, namely, the highest value of the advertisement effect is selected as a content to be output. Then, the content selection unit 113 transmits the content ID of the content to the output device 150 (S705).

When acquiring the content ID from the content selection unit 113, the output device 150 reproduces the content associated with the content ID from among the plurality of output candidate contents being previously acquired from the content server 140 and accumulated, and outputs the content to a flat-panel display and the like.

As described above, the content selection device 110 according to the first example embodiment recognizes the characteristic about the plurality of persons included in the image data, and predicts an individual advertisement effect on each of the plurality of persons for each content based on the recognized characteristic of the plurality of persons. Then, the content selection device 110 predicts the advertisement effect on the plurality of persons for each content by totaling a prediction value of each of the individual advertisement effects for each content. In this way, an effect capable of selecting the content having the highest advertisement effect on the plurality of persons included in the image data can be acquired.

### Modified Example 1

A streaming type can be adopted as a moving video distribution method to the output device 150. In this case, when acquiring the content ID from the content selection unit 113, the output device 150 requests actual data about the content associated with the content ID from the content server 140. The content server 140 acquires, from the content storage unit 142, the actual data about the content associated with the content ID acquired from the output device 150 via the input and output unit 141, and transmits the acquired actual data to the output device 150. The output device 150 outputs the content by using the actual data about the content acquired from the content server 140.

The content selection unit 113 instead of the output device 150 may transmit the content ID to the content server 140, and the content server 140 may transmit the actual data about the content associated with the content ID to the output device 150.

Further, in the prediction phase, the content selection system 100 may generate the characteristic recognition information in accordance with time at which the content is output, and may select the content to be output next. For example, when the content is output for 30 seconds, the content selection system 100 may generate the characteristic recognition information at every 30 second, and may select the content to be output next.

### Modified Example 2

The advertisement effect may be a sales amount of a product purchased by the person located in the visual recognition range when the content is presented. In the present modified example, in the analysis phase, the content selection system 100 analyzes a relationship among the characteristic of person, the context data, and sales of a product purchased by the person located in the visual recognition range when the content is presented. Then, the content selection system 100 generates the prediction model for predicting the sales amount of the product purchased by the person located in the visual recognition range of the presented content. In the prediction phase, the content selection system 100 selects the content having the higher predicted sales amount based on the prediction model when the content is presented for the plurality of persons located in the image range, and outputs the content.

In this case, in the analysis phase, the input and output unit 131 of the analysis server 130 receives image data from an image device (not illustrated). The image data here is captured by the image device at a product purchase place in a facility where the output device 150 is installed. Further, the analysis server 130 receives sales data including a sales amount in the facility. Herein, the sales data may be received from the management terminal 160, or may be received from a point of sale (POS) terminal (not illustrated). The analysis server 130 associates a feature of the person captured in the image data with the sales data of the person.

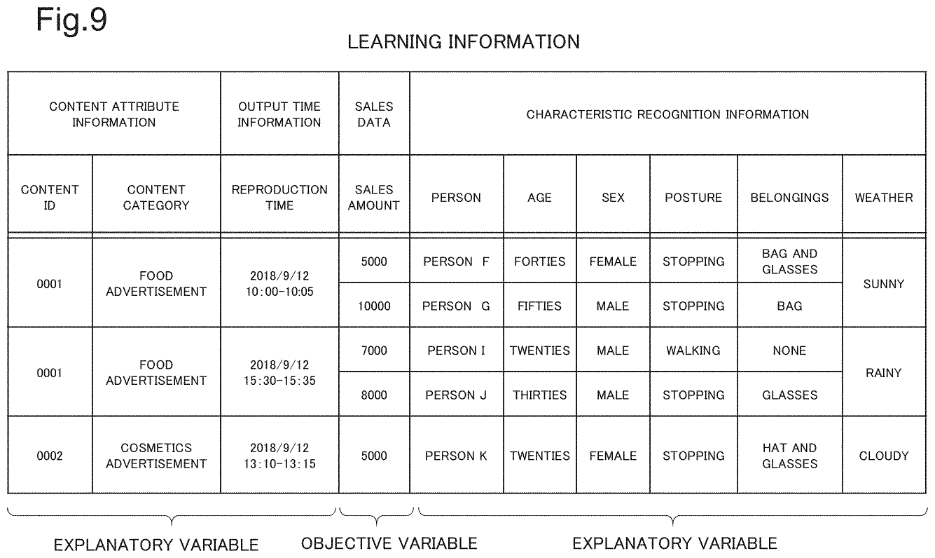

When a feature of person included in the characteristic recognition information acquired from the content selection device 110 matches the feature of person associated with the sales data, the prediction model generation unit 132 extracts the sales data, and generates learning information acquired by further associating the sales data with the learning information. FIG. 9 is a diagram illustrating one example of the learning information according to the present modified example.

The prediction model generation unit 132 generates the prediction model for predicting the advertisement effect (sales amount) by using the information illustrated in FIG. 9. For example, it is assumed that sales (“sales amount” in FIG. 9) of a product is an objective variable, and other information (“content ID”, “reproduction time”, “content category”, “age”, “sex”, “posture”, and “weather” in FIG. 9) is an explanatory variable. In this occasion, the analysis server 130 generates the prediction model as in Equation 2 below.

“Sales”=β₀×“content ID”+β₁×“reproduction time”+ . . . +β_{N-1}×“weather” (Equation 2)

where, βₙ (n is an integer from 0 to N−1, N is a number of an explanatory variable) in Equation 2 is a coefficient of each explanatory variable.

In the prediction phase, the advertisement effect prediction unit 112 acquires a value of an objective variable by substituting a numerical value for each explanatory variable. In other words, the advertisement effect prediction unit 112 calculates a value of the individual advertisement effect for each person by using the prediction model as in Equation 2. Then, the advertisement effect prediction unit 112 predicts the value of the advertisement effect for each content by totaling the calculated values for each content.

The content selection unit 113 acquires the value of the advertisement effect predicted by the advertisement effect prediction unit 112, and selects the content having the highest value of the advertisement effect as a content to be output among the output candidate contents.

Note that, the sales data in the present modified example may be sales of all purchased products of a target person, may be sales of a product related to the output content among the purchased products, or may be sales of a product related to a content category of the output content among the purchased products.

### Second Example Embodiment

In a second example embodiment, an example of calculating a priority based on a prediction result of the advertisement effect described in the first example embodiment, and selecting the content to be output by using the priority is described. Note that, a configuration of a content selection system according to the second example embodiment is similar to the configuration of the content selection system illustrated in FIG. 3 except for the content selection device. Hereinafter, description of a content overlapping the description of the first example embodiment described above is omitted.

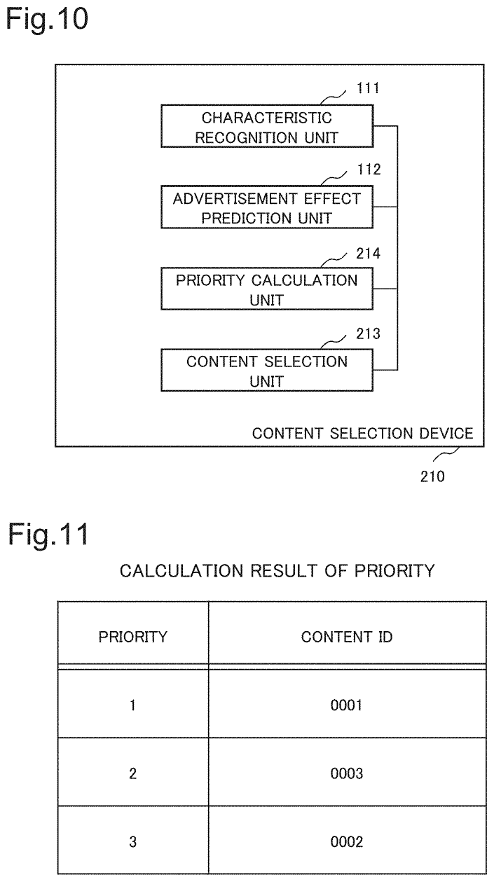

FIG. 10 is a block diagram illustrating a configuration of a content selection device 210 according to the second example embodiment. The content selection device 210 includes the characteristic recognition unit 111, the advertisement effect prediction unit 112, a content selection unit 213, and a priority calculation unit 214. The characteristic recognition unit 111 and the advertisement effect prediction unit 112 are similar to those in the first example embodiment.

The priority calculation unit 214 determines the priority for outputting the content based on the value of the advertisement effect predicted by the advertisement effect prediction unit 112. In other words, the priority calculation unit 214 is equivalent to a priority calculation means for calculating the priority for each content based on the advertisement effect predicted by the advertisement effect prediction unit 112. In the second example embodiment, an example of determining the priority when the priority calculation unit 214 acquires the calculation result of the advertisement effect as illustrated in FIG. 8 is described.

FIG. 11 is a diagram illustrating one example of the priority calculated by the priority calculation unit 214. FIG. 11 illustrates that the priority calculation unit 214 calculates priorities “1”, “2”, and “3” in descending order of values of advertisement effects, namely, for the content IDs “0001”, “0003”, and “0002” respectively based on the calculation result illustrated in FIG. 8.

When acquiring the calculation result of the priorities from the priority calculation unit 214, the content selection unit 213 selects the content to be output based on the priorities. In other words, in a case of the example of FIG. 11, the content selection unit 213 makes a selection in such a way that the content whose content ID having the highest priority (having the priority of “1”) is associated with “0001” is output. The content selection unit 213 may make a selection in such a way that a content is output in order of contents having the highest priority. Further, when a content having the priority of “1” is the same content as a content being output just previously, the content selection unit 213 may make a selection in such a way that a content having the second highest priority (a content having the priority of “2”) is output. Further, when the content having the highest priority is output for a predetermined number of times or more during a fixed period of time, the content selection unit 213 may make a selection in such a way that the content having the second highest priority is output.

As described above, the content selection device 210 according to the second example embodiment calculates the priority for each content based on the predicted value of the advertisement effect, and determines an order of presenting the content based on the priority. In this way, an effect capable of outputting the content without successively outputting the same content or outputting the content at an extremely high frequency can be acquired.

### Third Example Embodiment

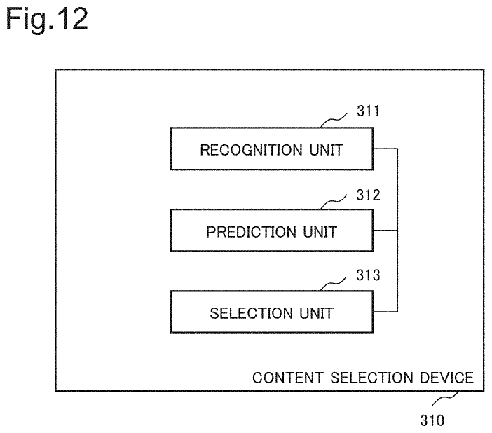

FIG. 12 is a block diagram illustrating a minimum configuration of a content selection device 310 according to a third example embodiment of the present invention. As illustrated in FIG. 12, the content selection device 310 includes a recognition unit 311, a prediction unit 312, and a selection unit 313. Configurations of the recognition unit 311, the prediction unit 312, and the selection unit 313 are similar to the configurations of the characteristic recognition unit 111, the advertisement effect prediction unit 112, and the content selection unit 113 according to the first example embodiment, respectively. Thus, detailed description thereof is omitted.

The recognition unit 311 acquires image data captured by an image device and recognizes a characteristic of person with respect to each of a plurality of persons included in the image data.

The prediction unit 312 predicts an advertisement effect on the plurality of persons for each of contents based on the characteristic of person.

The selection unit 313 selects a presentation content based on the advertisement effect, the presentation content being a content to present to the plurality of persons. In addition, the selection unit 313 displays the presentation content on an output device.

As described above, the content selection device 310 according to the third example embodiment can acquire an effect capable of selecting a content having a high advertisement effect on a plurality of persons included in image data.

In Japanese Unexamined Patent Application Publication No. 2009-245364, an advertisement frame in which an advertisement is distributed is selected based on a desired advertisement effect set for an advertisement and an advertisement effect predicted for each advertisement frame. The advertisement effect for each advertisement frame is predicted based on information about a person who visually recognizes an advertisement at the same time in the past. However, information about image data at a point in time when the advertisement is presented is not taken into consideration for predicting the advertisement effect. Thus, an advertisement having a high advertisement effect cannot be necessarily selected for a plurality of persons included in the image data.

Also, Japanese Unexamined Patent Application Publication No. 2008-102176 does not disclose that an advertisement having a high advertisement effect on a plurality of persons included in image data is output.

While the present invention is described with reference to the above-mentioned example embodiments, the present invention is not limited thereto. That is, within the scope of the present invention, different aspects, such as a wide range of combination or selection of the above-disclosed various elements, that may be understood by those skilled in the art can be applied to the present invention.

1. A computer-implemented method of selecting content, the method performed by one or more processors, comprising:
receiving image data captured by an image device;
recognizing a characteristic of person with respect to each of a plurality of persons included in the image data;
predicting an advertisement effect on the plurality of persons for each of contents based on the characteristic of person;
selecting a presentation content based on the advertisement effect, the presentation content being a content to present to the plurality of persons; and
displaying the presentation content on an output device.

2. The computer-implemented method of selecting content according to claim 1, further comprising:
predicting an individual advertisement effect for each of the plurality of persons for each of contents, and predicting the advertisement effect by totaling the individual advertisement effect.

3. The computer-implemented method of selecting content according to claim 2, further comprising
predicting the individual advertisement effect based on the characteristic of each of the plurality of persons and a prediction model, wherein the prediction model is for predicting the individual advertisement effect from the characteristic of person.

4. The computer-implemented method of selecting content according to claim 1, wherein
the characteristic of person includes at least one of sex, age, a posture, a facial expression, clothing, a body shape, belongings held by the person, a walking speed, and a distance between the person and the output device.

5. The computer-implemented method of selecting content according to claim 1, wherein
the advertisement effect indicates an effect of the content appealing to the plurality of persons.

6. The computer-implemented method of selecting content according to claim 5, wherein
the advertisement effect includes at least one of a value indicating whether the plurality of persons visually recognize the content, a frequency of the plurality of persons coming to a store related to the content, a degree to which the plurality of persons pick up a product related to the content, and a sales amount of a product purchased by the plurality of persons.

7. The computer-implemented method of selecting content according to claim 1, further comprising:
calculating a priority of the content based on the advertisement effect; and
determining, based on the priority of each content, an order of presenting the contents.

8. The computer-implemented method of selecting content according to claim 1, further comprising:
predicting the advertisement effect on the plurality of persons for each of contents based on the characteristic of person and context data, the context data being information about an environment in which the content is displayed.

9. The computer-implemented method of selecting content according to claim 8, wherein
the context data include at least one of weather, temperature, event information, a congestion degree, date and time, and a place.

10. The computer-implemented method of selecting content according to claim 1, wherein
an image range captured by the image device includes a visual recognition range, the visual recognition range being an area where the content displayed on the output device is capable of being recognized.

11. A content selection system, comprising:
a content selection device that includes a processor configured to:
recognize a characteristic of person with respect to each of a plurality of persons included in image data,
predict an advertisement effect on the plurality of persons for each of contents based on the characteristic of person, and
select a presentation content to the plurality of persons based on the advertisement effect, the presentation content being a content to present to the plurality of persons;
an image device that generates the image data; and
an output device that acquires a content ID to indicate the presentation content from the content selection device, and outputs the presentation content selected based on the content ID.

12. A non-transitory computer-readable recording medium that stores a program causing a computer to execute:
receiving image data captured by an image device;
recognizing a characteristic of person with respect to each of a plurality of persons included in the image data;
predicting an advertisement effect on the plurality of persons for each of contents based on the characteristic of person;
selecting a presentation content based on the advertisement effect, the presentation content being a content to present to the plurality of persons; and
displaying the presentation content on an output device.
